(19) United States
(12) Patent Application Publication
(10) Pub. No.: US 2023/0006833 A1
(43) Pub. Date: Jan. 5, 2023

(54) RANKED HASH VALIDATION FOR NEW SOFTWARE UPDATE FILE

(71) Applicant: Lenovo (Singapore) Pte. Ltd., Singapore (SG)

(72) Inventors: Igor Stolbikov, Apex, NC (US); Scott Wentao Li, Cary, NC (US); Joshua N. Novak, Wake Forest, NC (US)

(21) Appl. No.: 17/365,707

(22) Filed: Jul. 1, 2021

(51) Int. Cl. H04L 9/32; G06F 8/65; G06F 21/57

(52) U.S. Cl. CPC H04L 9/3239; G06F 8/65; H04L 9/3247; G06F 21/572; G06F 2221/033

(57) ABSTRACT

In one aspect, a device may include a processor and storage with instructions executable to identify a ranking of different chunks of a new update file, with the different ranks associated with different hashing algorithms. The instructions may also be executable to determine whether a respective newly-received hash for a respective chunk of the new update file is different from a respective prior hash of a prior software version for the same respective chunk. Responsive to the respective newly-received hash being different from the respective prior hash for the same chunk, the instructions may be executable to attempt to validate the respective chunk using the respective hashing algorithm associated with the respective rank for the respective chunk. Responsive to the respective newly-received hash being the same as the respective prior hash for the same respective chunk, the instructions may be executable to decline to attempt to validate the respective chunk.

### FIELD

The disclosure below relates to technically inventive, non-routine solutions that are necessarily rooted in computer technology and that produce concrete technical improvements. In particular, the disclosure below relates to techniques for ranked hash validation for new software update files.

### BACKGROUND

As recognized herein, many peripheral devices have low-power microprocessor units that are many orders of magnitude less powerful than higher-powered central processing units (CPUs) that are included in many of today's high-powered computers. As such, it can take these microprocessor units much more time to perform certain tasks.

As also recognized herein, one of these tasks may be firmware update validation for integrity and authenticity. This task can take hundreds of seconds using a microprocessor unit, which the present application recognizes is far too long and can unnecessarily consume processing resources that should be devoted to other tasks. Moreover, the present application recognizes that while these validation techniques use hashing tools that can take thousands and thousands of years to successfully crack, peripheral device security need not last nearly that long as the devices and firmware are typically only used for a few years.

The present application further recognizes that while validation might sometimes be outsourced to a high-powered CPU connected to the peripheral device, this tactic provides hackers with a network gap that they can exploit to corrupt the process and compromise device security without the peripheral device or connected device even knowing about it, let alone remedying it.

There are therefore currently no adequate solutions to the foregoing computer-related, technological problems.

### SUMMARY

Accordingly, in one aspect a first device includes at least one processor and storage accessible to the at least one processor. The storage includes instructions executable by the at least one processor to identify a ranking of different chunks of a new update file, with the ranking including at least two different ranks associated with different hashing algorithms. The instructions are also executable to determine whether a respective newly-received hash for a respective chunk of the new update file is different from a respective prior hash of a prior software version for the same respective chunk. The respective newly-received hash is received with the new update file and the respective prior hash relates to a previous update of the software or an original version of the software. Responsive to the respective newly-received hash for the respective chunk of the new update file being different from the respective prior hash for the same respective chunk, the instructions are executable to attempt to validate the respective chunk of the new update file using the respective hashing algorithm associated with the respective rank for the respective chunk of the new update file. Responsive to the respective newly-received hash for the respective chunk of the new update file being the same as the respective prior hash for the same respective chunk, the instructions are executable to decline to attempt to validate the respective chunk of the new update file.

Thus, in some examples the instructions may be executable to perform an update of the respective chunk using the new update file responsive to validation of the respective chunk of the new update file using the respective hashing algorithm associated with the respective rank for the respective chunk of the new update file, and to decline to perform the update for the respective chunk using the new update file responsive to not validating the respective chunk of the new update file using the respective hashing algorithm associated with the respective rank for the respective chunk of the new update file. Declining to perform the update for the respective chunk using the new update file might include declining to perform any update of the software using the new update file. Additionally, in some examples the instructions may be executable to transmit a notification to a second device different from the first device indicating that the respective chunk of the new update file could not be validated responsive to not validating the respective chunk of the new update file using the respective hashing algorithm associated with the respective chunk of the new update file.

In some example implementations, the determination may be performed by comparing hashes in a hash tree for the new update file and a hash tree for the prior software version to identify a hash for a particular leaf indicated in both trees as having changed relative to the prior software version. Furthermore, in some examples the instructions may be executable to verify a digital signature for the hash tree for the new update file prior to installing the new update file, where the digital signature may be received with the new update file.

Also in various example implementations, the different hashing algorithms may be established at least in part by different numbers of permutations used for each hashing algorithm. Thus, a rank associated with a file directory chunk for the new update file may be associated with a hashing algorithm with more permutations than a hashing algorithm associated with a different rank.

Still further, in some embodiments the instructions may be executable to identify, in a header for the new update file for the software, the ranking of different chunks of the new update file. Additionally, or alternatively, the instructions may be executable to identify, via a directory for the update file, the ranking of different chunks of the new update file.

Also in some examples, the first device may include a peripheral device, where the new update file may pertain to a firmware update for the peripheral device. Also, if desired the processor may include a microprocessor and the microprocessor may execute the instructions locally in the peripheral device. The peripheral device itself may be established by a headset, headphones, a keyboard, a mouse, a wireless speaker, a dock or hub device, a display, a printer, a stylus, a camera, a microphone, a network repeater, a wireless access point, an external network adapter, a router, a modem, and/or an external hard drive.

In another aspect, a method includes identifying a ranking of different chunks of a new update file. The ranking includes at least two different ranks, and the different chunks are associated with different hashing algorithms. The method also includes determining whether a respective newly-received hash for a respective chunk of the new update file is different from a respective prior hash of a prior software version for the same respective chunk. The respective prior hash relates to a previous update of the software or an original version of the software. Then responsive to the respective newly-received hash for the respective chunk of the new update file being different from the respective prior hash for the same respective chunk, the method includes attempting to validate the respective chunk of the new update file using the respective hashing algorithm associated with the respective chunk of the new update file. Responsive to the respective newly-received hash for the respective chunk of the new update file being the same as the respective prior hash for the same respective chunk, the method includes declining to attempt to validate the respective chunk of the new update file.

Thus, in certain examples the method may include performing an update of the respective chunk using the new update file responsive to validating the respective chunk of the new update file using the respective hashing algorithm associated with the respective chunk of the new update file, and declining to perform the update for the respective chunk using the new update file responsive to not validating the respective chunk of the new update file using the respective hashing algorithm associated with the respective chunk of the new update file.

Also, in various example implementations the determining may be performed by comparing hashes in a hash tree for the new update file with hashes in a hash tree for the prior software version to identify a hash for a particular leaf indicated in both trees as having changed relative to the prior software version.

The different hashing algorithms may be established at least in part by different numbers of permutations used for each hashing algorithm in certain example implementations. Also, the new update file may pertain to a firmware update.

In still another aspect, at least one computer readable storage medium (CRSM) that is not a transitory signal includes instructions executable by at least one processor to identify a ranking of different chunks of a new update file. Different rankings for different chunks are associated with different hashing algorithms of different strengths. The instructions are then executable to determine whether a respective newly-received hash for a respective chunk of the new update file is different from a respective prior hash of a prior software version for the same respective chunk. The respective prior hash relates to a previous update of the software or an original version of the software. Responsive to the respective newly-received hash for the respective chunk of the new update file being different from the respective prior hash for the same respective chunk, the instructions are executable to attempt to validate the respective chunk of the new update file using the respective hashing algorithm associated with the respective rank for the respective chunk of the new update file. Responsive to the respective newly-received hash for the respective chunk of the new update file being the same as the respective prior hash for the same respective chunk, the instructions are executable to decline to attempt to validate the respective chunk of the new update file.

Thus, in certain examples the different strengths of the different hashing algorithms may be established at least in part by different numbers of iterations used for the different hashing algorithms. Also in certain examples, the determination may be performed by comparing hashes in a hash tree for the new update file with hashes in a hash tree for the prior software version to identify a hash for a particular leaf indicated in both trees as having changed relative to the prior software version.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 illustrates example logic in example flow chart format that may be executed by a device consistent with present principles;

FIG. 4 shows an example schematic diagram of an example hash tree consistent with present principles;

FIG. 5 shows an example data table ranking various firmware update chunks and indicating associated hash algorithms of different strengths to use for the various chunks consistent with present principles;

FIG. 6 shows an example graphical user interface (GUI) that may be presented on a display of a device of a manufacturer/distributor in the event an update file has been identified as potentially compromised consistent with present principles; and

FIG. 7 shows an example GUI that may be presented on a display of an end user's device in the event an update file has been identified as potentially compromised consistent with present principles.

### DETAILED DESCRIPTION

Among other things, the detailed description below discloses splitting firmware into chunks that are ranked based on the level of security desired for the corresponding chunk data. A header or other part of an update file may be used to describe the predefined chunks in the file.

For example, a Windows binary file may have a portable executable (PE) header, located at the beginning of the binary, that describes the file's headers, sections, checksum, and certificate information. The chunks may be ranked in the header and indicate other high-security sections of the file such as a Windows-specific header (including the checksum, which may be located at the top of the file), a certificate table, executable code sections, and an authenticode signatures table (e.g., containing the file's digital certificates themselves, often located at bottom of the file). Then other sections of the file that can use less secure hashing methods/smaller numbers of permutations may include data sections, resource sections, debugging sections, etc. The manufacturer or developer of the peripheral device may adjust each section to be assigned a given security level based on various application-specific needs.

Another example might be in the context of a zip file, where each file entry, and the file's data, is located in a central directory at the end of the file. Here too the chunks may be ranked using the directory for higher-security portions and lower-security portions. Thus, any file chunk assigned to a higher level of security may use a stronger hashing algorithm/bigger number of iterations than other chunks assigned to lower levels of security. The final central directory itself may in some examples be assigned the highest available security level and thus be protected by the most-secure hashing algorithm available.

Thus, based on file type, the file definition may be parsed to determine which sections/chunks are more important to protect.

The update package structure may also be reflected in a hash tree/Merkle tree assembled into the update package itself. Each leaf of the tree may for example include Type|id|hash value (and possibly also the chunk itself). Depending on the type of chunk, different numbers of permutations may be used. For example, for high-risk types, a “full” number of permutations, such as twenty-four, may be used. For lower-risk types, a small number of permutations may be used (e.g., eight). Since much of the data may be relatively low-risk, using eight permutations for those chunks may significantly improve the performance of the device's processor during validation while also providing adequate security for the life of the peripheral device. Thus, while using eight permutations is weaker than twenty-four, it still provides sufficiently strong security and matching (e.g., for 128-bit security).

The tree itself may be hashed using the full number of permutations/strongest available hashing algorithm. The tree may also be signed by the firmware distributor.

The verification process at the local peripheral device may then use the knowledge of the previous firmware version and any identified changes. For example, the verification process may start upside down in the hash tree so that it starts with the verification of the top signature as matching to the trusted provider. The process may then move to compare hashes of next, lower layers of nodes, and so on.

The process may thus compare the hashes of the respective chunks of the new update file with existing firmware chunk hashes for the same respective chunks but for the prior version. Any chunks/nodes with matching hashes between versions may be skipped and not verified and/or installed. Thus, only modified file chunks may be verified using a certain number of hashing permutations during the hash calculations that is based on the assigned security level/importance of the respective chunks.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general-purpose single- or multi-chip processor that can execute logic by means of various lines such as address lines, data lines, and control lines and registers and shift registers. Moreover, any logical blocks, modules, and circuits described herein can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to hypertext markup language (HTML)-5, Java/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI and includes programmable logic components programmed to perform the functions of an embodiment as well as general-purpose or special-purpose processors programmed with instructions to perform those functions.

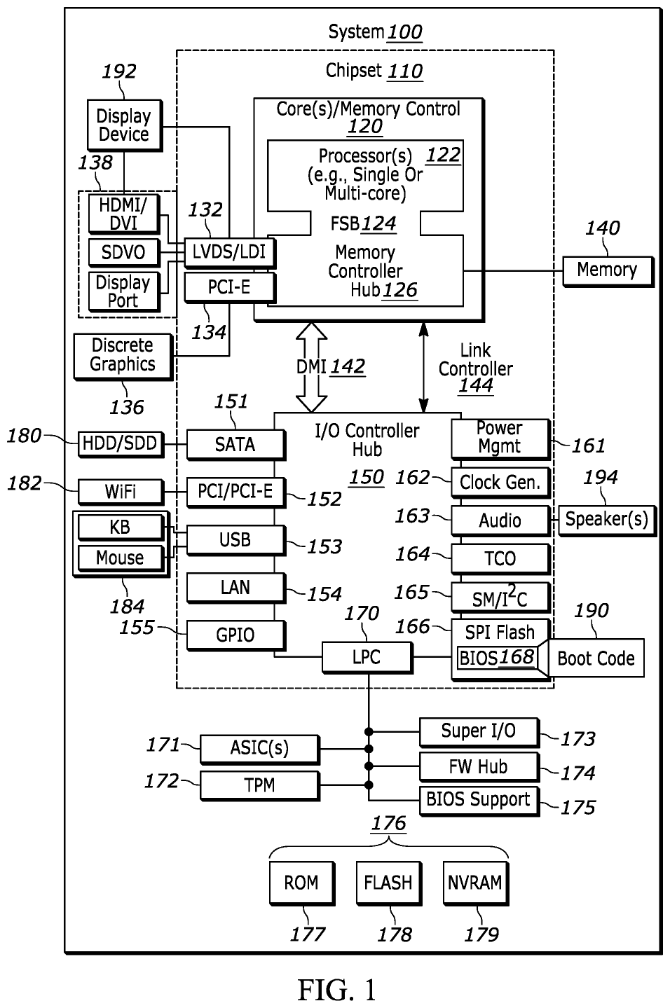

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a LAN interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing, or reading and writing information on one or more drives 180 such as HDDs, SDDs or a combination thereof, but in any case, the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor 122, as well as an accelerometer that senses acceleration and/or movement of the system 100 and provides related input to the processor 122. Still further, the system 100 may include an audio receiver/microphone that provides input from the microphone to the processor 122 based on audio that is detected, such as via a user providing audible input to the microphone. The system 100 may also include a camera that gathers one or more images and provides the images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video. Also, the system 100 may include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

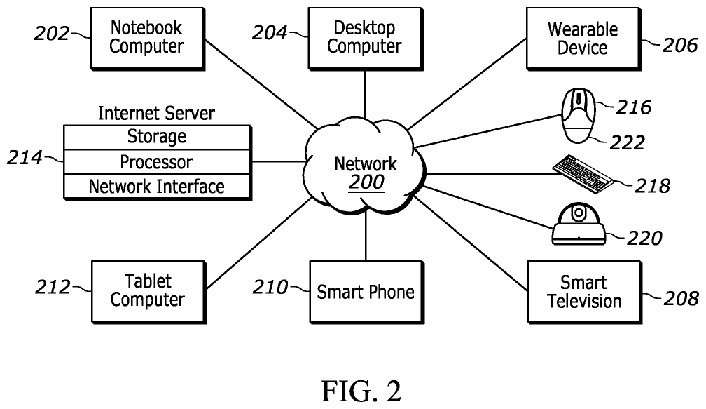

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a wireless mouse 216, a wireless keyboard 218, a wireless camera 220, and a server 214 such as an Internet server that may provide cloud storage accessible to the devices 202-212, 216-220. It is to be understood that the devices 202-220 may be configured to communicate with each other over the network 200 to undertake present principles.

For example, the server 214 may push a firmware update to one of the peripheral devices 216-220 through the notebook computer 202 or desktop computer 204 based on the computer 202/204 being in Bluetooth or other short-range wireless communication with the respective peripheral device. Then after the server 214 routes the update through the computer 202/204 to the peripheral device, the peripheral device may use its local microprocessor/microcontroller within the peripheral device itself to install the update as described herein. An example microprocessor 222 for the mouse 216 is thus shown in FIG. 2, with microprocessors for the devices 218, 220 being omitted from FIG. 2 for simplicity. Each microprocessor in each peripheral device may be embodied in an application-specific integrated circuit (ASIC) or other integrated circuit, field-programmable gate array (FPGA), metal-oxide-semiconductor field-effect transistor (MOSFET), digital signal processor (DSP), or other suitable unit.

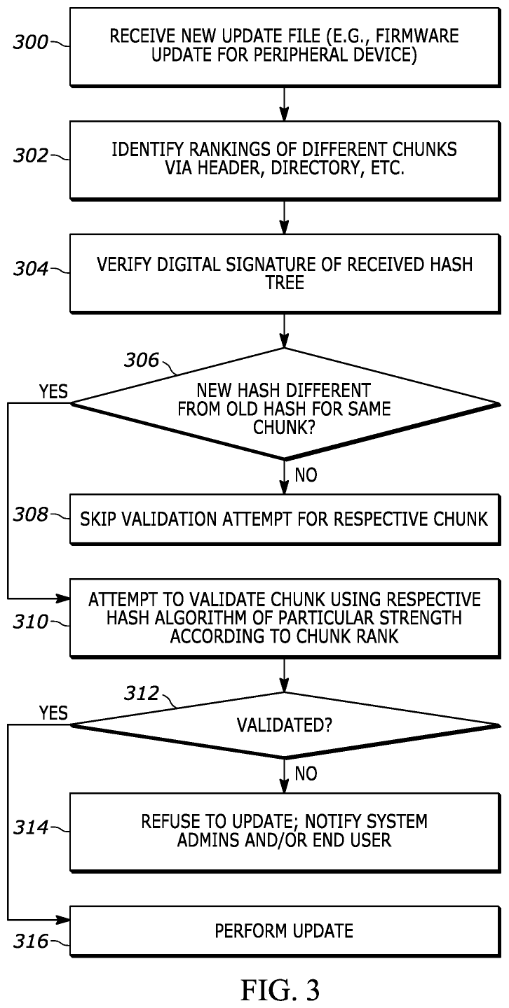

Also note before describing FIG. 3 that a peripheral device consistent with present principles is not limited to wired or wireless keyboards, mice, and cameras but may also include wired and/or wireless headsets (e.g., Bluetooth headset for phone calls), headphones, speakers, docks or hub devices, a displays/monitors, printers, styluses, microphones, network repeaters, wireless access points, external network adapters, routers, modems, external hard drives, various types of Internet of things (IoT) devices, smart home devices, etc.

Referring now to FIG. 3, it shows example logic that may be executed locally by a processor within a peripheral device consistent with present principles in order to perform ranked hash validation for a new update file so that adequate digital security for software updates may be provided while also not over-burdening the device's local processor. The update file may be for, for example, updating the firmware of a device such as webcam, stand-alone microphone, keyboard, etc. The update file may be a zip file or Windows binary file, for example. Also note that while the logic of FIG. 3 is shown in flow chart format, state logic or other suitable logic may also be used. Further note that the peripheral device will be described in reference to FIG. 3 as a “first device”.

Beginning at block 300, the first device may receive and cache a new update file, such as a new firmware update for the first device's firmware that has been pushed to the peripheral device or otherwise downloaded. The update may be an update from a previous version of the first device's software/firmware, whether the previous version was itself an update or an original version of the software/firmware. The update file may be received from a local computer such as a laptop, tablet, or desktop computer that is in Wi-Fi, wireless USB, or Bluetooth communication with the first device, for example. After block 300 the logic may move to block 302.

At block 302 the first device may access a header for the new update file, a file directory for the new update file, or another portion of the new update file to identify a ranking of different chunks of a new update file as established by the provider or developer of the new update file. The ranking may include at least two different ranks associated with different hashing algorithms of different strengths. The chunks themselves may be established by discrete portions of the new update file, such as the file's executable, the file's directory, the file's text document, an image file, a new hash tree, etc. However, in other examples the chunks may be smaller chunks of data within those discrete portions, or even chunks of data across multiple discrete portions, where in either case the chunks may be of a preestablished size as specified by the developer (e.g., 100 megabytes (MB)). Regardless, as for the new hash tree, while it may be provided in the update file separate from the file's directory, in some examples it may be included in the directory or root itself.

After block 302 the logic may proceed to block 304 where the first device may in some examples use public/private key asymmetric cryptography to verify the digital signature for the new hash tree received as part of the update file. This may be done using the appropriate public key that is reciprocal to the private key used to generate the digital signature itself. The digital signature may either sign just the new hash tree itself or sign the entire update file and/or root/root hash, for example.

If the authenticity of the digital signature cannot be verified, the logic may end. But assuming the digital signature is verified, the logic may next move to decision diamond 306. At diamond 306 the first device may determine, for each leaf of the new hash tree which itself may establish a respective chunk, whether the newly-received hash for the respective chunk as indicated in the new hash tree is different from an older/prior hash for the same respective chunk as indicated in an older hash tree for the prior version. The older hash tree may be stored locally at the first device and may be from an immediately prior update file or the original software version for the firmware.

If the hashes for the respective chunk are determined to be the same once compared, this indicates that no new updates to the firmware are included in that respective chunk compared to the prior version for the same respective chunk, thus leading to a negative determination at diamond 306. The negative determination may cause the logic to then proceed to block 308 where the first device may skip a validation attempt for the respective chunk. After block 308 the logic may then move on to another chunk of the received update file and perform the determination at diamond 306 again for that chunk. This process may continue for each chunk of the new update file until a chunk is reached for which an affirmative determination is made at diamond 306.

Then once hashes for a same respective chunk are determined to be different between the firmware versions at diamond 306, this indicates that the respective chunk has been updated or otherwise changed compared to the immediately prior version. Accordingly, an affirmative determination may be made at diamond 306, which may then cause the logic to then proceed to block 310 where the first device may attempt to validate the new version of the respective chunk.

The validation attempt at block 310 may be performed using a particular hash algorithm assigned to the rank associated with the respective chunk itself. The different hashing algorithms for the different ranks may be pre-stored at the first device by the first device's manufacturer along with the different ranks assigned to each one. In various examples, the different hashing algorithms may vary in strength at least by the number of iterations/permutations performed as part of the respective algorithm so that higher-ranked algorithms use more iterations/permutations for hashing than other hash algorithms associated with lower ranks. The hash algorithms may be one or more from the family of Keccak algorithms, and specifically the family of Secure Hash Algorithms (SHAs) such as SHA-1, SHA-2, or SHA-3 algorithms (e.g., SHA-256, SHA-384, SHA-512). However, the algorithms may also be established by other hash algorithms such as MD5, BLAKE, BLAKE2, BLAKE3, KangarooTwelve, RIPEMD, etc.

Thus, by using less-robust hashing algorithms with less permutations for chunks of the update file that have been assigned lower priorities, in combination with only attempting to validate respective chunks for which a respective newly-received hash is different from a prior hash version, processing constraints on the peripheral device's microprocessor are reduced and the efficiency and functionality of the microprocessor is enhanced in executing the update while still providing adequate security for the peripheral device's firmware. For instance, firmware updates may only need to withstand two to five years' worth of attacks instead of thousands or millions of years' worth of attacks as would be ensured by using a robust, high-permutation hashing algorithm for the entire update file. This is because peripheral devices are typically only used for a few years before being replaced or rendered obsolete by newer models, and/or their firmware rendered obsolete by further updates.

Thus, from block 310 the logic of FIG. 3 may then move to decision diamond 312. At diamond 312 the first device may actually compare the hash it generated at block 310 for the respective chunk of the new update file to the corresponding hash for the same respective chunk of the new update file as indicated in the newly-received hash tree that was signed with the digital signature to determine whether the two hashes match.

A negative determination at diamond 312 may cause the logic to proceed to block 314 where the first device may decline/refuse to execute any part of the firmware update using the new update file since the mismatch of the hashes indicates a hacker or other nefarious party might have compromised the firmware update in transit to the peripheral device itself and possibly inserted malware, viruses, etc. into the update file. If desired, at block 314 the first device may also route a message or other notification through the computer to which it is connected to the provider, developer, or system administrator for the update file that indicates the respective chunk could not be validated and that the update file has possibly been compromised owing to the hash mismatch. Also, if desired, at block 314 the first device may communicate with the computer to also present a message or other notification to the local end user via the computer's display and/or speakers that the respective chunk could not be validated and that the update file will not be installed.

However, if an affirmative determination is made at diamond 312 instead (e.g., a hash match), then the logic may instead proceed to block 316. At block 316 the logic may repeat the foregoing process of FIG. 3 for remaining chunks of the new update file that have not yet been validated and ultimately perform/install the firmware update to update the respective chunk and any others that are new compared to prior versions and validated.

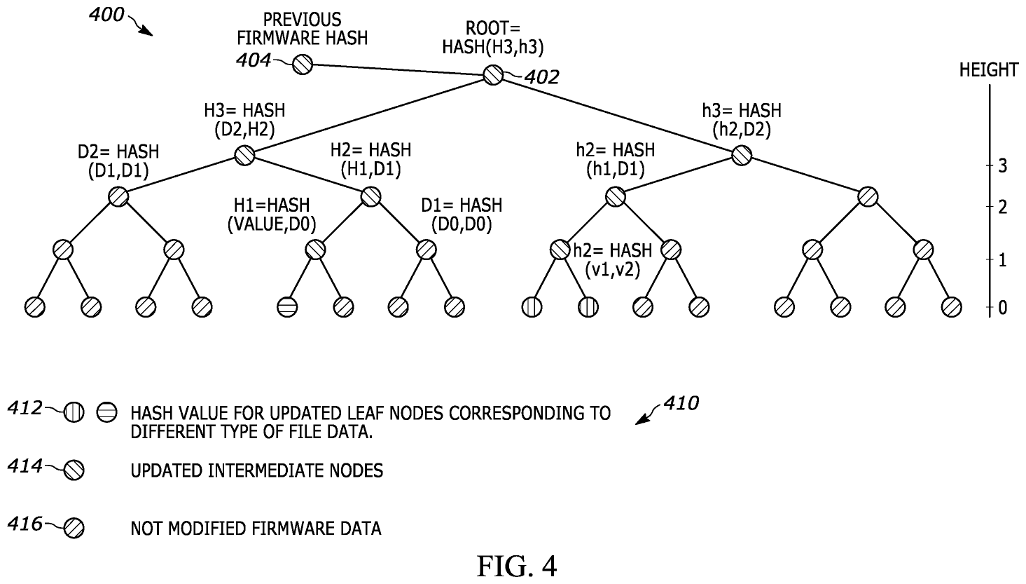

Now referring to FIG. 4, it shows a schematic diagram 400 consistent with present principles of an example hash tree according to a root file structure, where a root for a particular firmware update/version has a root hash 402 for the root file. As a preliminary check, the microprocessor on the peripheral device may compare the root hash 402 as received as part of a new update file to a previous firmware root hash 404 of a previous root of an immediately prior version of the same firmware (as already stored at the peripheral device) to determine whether anything in any portion of the new update file is different from the previous version. If the hashes 402, 404 are different, the logic of FIG. 3 may then be executed.

As also shown in FIG. 4, the hash tree may include hashes for each respective intermediate node (an example of a discrete chunk) at levels one, two, and three as shown. The hash tree may also include hashes for each respective bottom-level leaf node (another example of a discrete but possibly smaller chunk) at the bottom of the hash tree. Guide 410 is included to illustrate, with different shadings, hashes for different chunks in the hash tree that have either changed or not changed compared to an older hash tree for an immediately prior version of the same firmware. Thus, indicators 412 indicate, at the leaf node level for different types of files/data (e.g., executable vs. an image file), that different hashes have been identified for a respective chunk when comparing older and new hashes for that respective chunk. Indicator 414 indicates that different hashes have been identified for a respective chunk when comparing older and new hashes for that respective chunk at the intermediate node level. Indicator 416 indicates nodes at various levels for which respective newly-received hashes match respective older hash versions.

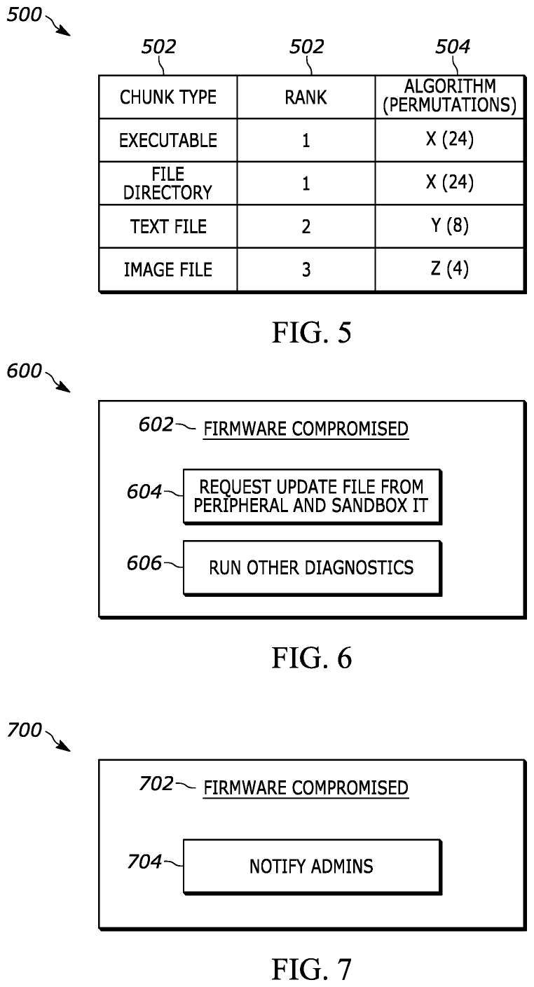

Continuing the detailed description in reference to FIG. 5, it shows an example data table 500 that may be stored locally at a peripheral device. The table 500 may have been preconfigured by the device's manufacturer, a software developer, system administrator, etc. The table 500 may indicate different chunk types in column 502, different associated ranks in column 504, and different associated hash algorithms of varying strengths in column 506.

As may be appreciated from FIG. 5, executables and file directory/final central directory chunks have the highest ranking and are therefore associated with a hashing algorithm with more permutations than a hashing algorithm associated with different, lower ranks for other chunk types such as text files and image files. Thus, after the peripheral device identifies the rankings or types of different chunks of a new update file (e.g., at block 302 of FIG. 3) as described above, the device may access the table 500 and determine which hash algorithm to use at block 310 based on the respective rank.

Now describing FIG. 6, it shows an example graphical user interface (GUI) 600 that may be presented on the display of a device associated with a manufacturer or developer of a peripheral device as a notification that a new update file has been determined by the peripheral device itself to have been potentially compromised. For example, the GUI 600 may be presented responsive to receiving a message from the peripheral device per the description of block 314 above. Thus, the GUI 600 may include a prompt 602 indicating that at least one chunk of the new update file could not be validated, and that the firmware update is therefore compromised.

The prompt 602 may prompt the manufacturer/admin to investigate the potential digital attack on the new update file by various means. Thus, the GUI 600 may include a selector 604 that may be selectable to transmit a request to the peripheral device itself to transmit the potentially compromised update file back to the manufacturer's device and sandbox it at the manufacturer's device (e.g., not giving it network access or access to other parts of the manufacturer's device) so that the manufacturer can compare the received and sandboxed update file to what the peripheral device was supposed to receive as a valid update file. However, if desired a selector 606 may also be selected to initiate other diagnostics at the manufacturer device, such as network diagnostics to identify a potential intrusion into the manufacturer's local network or the network between the peripheral device and manufacturer device itself.

Turning now to FIG. 7, it shows another example GUI 700 that may be presented on a display. However, the GUI 700 may be presented on the display of an end user's computer that communicates with a local peripheral device consistent with present principles (and/or that may be presented on the display of the peripheral device itself, it the device has one). The GUI 700 may serve as a notification to an end user per block 314 above that a new update file has been determined by the peripheral device itself to have been potentially compromised.

Thus, the GUI 700 may include a prompt 702 indicating that at least one chunk of the new update file could not be validated, and that the firmware update is therefore compromised. In some examples, like where the peripheral device does not autonomously notify the update file's system admins and/or the peripheral device manufacturer of the potentially compromised, the GUI 700 may include a selector 704 for the end user to command the computer to do so anyway.

Before concluding, it is to be understood that in some instances, hashes in a newly-received hash tree for a new update file may be compared to all prior hash trees of prior updates and the original version of software as stored in the peripheral device. In these examples, if each hash of the new tree matches each respective hash of any of the older trees, the new update may be rejected even if it contains hashes that are different relative to a most-recent prior update. This may be done so that an older version of the device's firmware that might be two or three generations older is not installed on instigation of a bad actor who discovered a security flaw in the older version of the firmware that can then be exploited.

It may now be appreciated that present principles provide for improved firmware/software updates that increase the functionality and efficiency of the underlying devices to which the firmware/software pertains. The disclosed concepts are thus rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A first device, comprising:
at least one processor; and
storage accessible to the at least one processor and comprising instructions executable by the at least one processor to:
identify a ranking of different chunks of a new update file, the ranking comprising at least two different ranks, the different ranks associated with different hashing algorithms;
determine whether a respective newly-received hash for a respective chunk of the new update file is different from a respective prior hash of a prior software version for the same respective chunk, the respective newly-received hash being received with the new update file, the respective prior hash relating to a previous update of the software or an original version of the software;
responsive to the respective newly-received hash for the respective chunk of the new update file being different from the respective prior hash for the same respective chunk, attempt to validate the respective chunk of the new update file using the respective hashing algorithm associated with the respective rank for the respective chunk of the new update file; and
responsive to the respective newly-received hash for the respective chunk of the new update file being the same as the respective prior hash for the same respective chunk, decline to attempt to validate the respective chunk of the new update file.

2. The first device of claim 1, wherein the instructions are executable to:
responsive to validation of the respective chunk of the new update file using the respective hashing algorithm associated with the respective rank for the respective chunk of the new update file, perform an update of the respective chunk using the new update file; and
responsive to not validating the respective chunk of the new update file using the respective hashing algorithm associated with the respective rank for the respective chunk of the new update file, decline to perform the update for the respective chunk using the new update file.

3. The first device of claim 2, wherein declining to perform the update for the respective chunk using the new update file comprises declining to perform any update of the software using the new update file.

4. The first device of claim 2, wherein the instructions are executable to:
responsive to not validating the respective chunk of the new update file using the respective hashing algorithm associated with the respective chunk of the new update file, transmit a notification to a second device different from the first device indicating that the respective chunk of the new update file could not be validated.

5. The first device of claim 1, wherein the determination is performed by comparing hashes in a hash tree for the new update file and a hash tree for the prior software version to identify a hash for a particular leaf indicated in both trees as having changed relative to the prior software version.

6. The first device of claim 5, wherein the instructions are executable to:
verify a digital signature for the hash tree for the new update file prior to installing the new update file, the digital signature received with the new update file.

7. The first device of claim 1, wherein the different hashing algorithms are established at least in part by different numbers of permutations used for each hashing algorithm.

8. The first device of claim 7, wherein a rank associated with a file directory chunk for the new update file is associated with a hashing algorithm with more permutations than a hashing algorithm associated with a different rank.

9. The first device of claim 1, wherein the instructions are executable to:
identify, in a header for the new update file for the software, the ranking of different chunks of the new update file.

10. The first device of claim 1, wherein the instructions are executable to:
identify, via a directory for the update file, the ranking of different chunks of the new update file.

11. The first device of claim 1, comprising a peripheral device, wherein the new update file pertains to a firmware update for the peripheral device.

12. The first device of claim 11, wherein the processor comprises a microprocessor, and wherein the microprocessor executes the instructions locally in the peripheral device.

13. The first device of claim 1, wherein the peripheral device is established by a headset, headphones, a keyboard, a mouse, a wireless speaker, a dock or hub device, a display, a printer, a stylus, a camera, a microphone, a network repeater, a wireless access point, an external network adapter, a router, a modem, and/or an external hard drive.

14. A method, comprising:
identifying a ranking of different chunks of a new update file, the ranking comprising at least two different ranks, the different chunks associated with different hashing algorithms;
determining whether a respective newly-received hash for a respective chunk of the new update file is different from a respective prior hash of a prior software version for the same respective chunk, the respective prior hash relating to a previous update of the software or an original version of the software;
responsive to the respective newly-received hash for the respective chunk of the new update file being different from the respective prior hash for the same respective chunk, attempting to validate the respective chunk of the new update file using the respective hashing algorithm associated with the respective chunk of the new update file; and
responsive to the respective newly-received hash for the respective chunk of the new update file being the same as the respective prior hash for the same respective chunk, declining to attempt to validate the respective chunk of the new update file.

15. The method of claim 14, comprising:
responsive to validating the respective chunk of the new update file using the respective hashing algorithm associated with the respective chunk of the new update file, performing an update of the respective chunk using the new update file; and
responsive to not validating the respective chunk of the new update file using the respective hashing algorithm associated with the respective chunk of the new update file, declining to perform the update for the respective chunk using the new update file.

16. The method of claim 14, wherein the determining is performed by comparing hashes in a hash tree for the new update file with hashes in a hash tree for the prior software version to identify a hash for a particular leaf indicated in both trees as having changed relative to the prior software version.

17. The method of claim 14, wherein the different hashing algorithms are established at least in part by different numbers of permutations used for each hashing algorithm.

18. The method of claim 14, wherein the new update file pertains to a firmware update.

19. At least one computer readable storage medium (CRSM) that is not a transitory signal, the computer readable storage medium comprising instructions executable by at least one processor to:
identify a ranking of different chunks of a new update file, wherein different rankings for different chunks are associated with different hashing algorithms of different strengths;
determine whether a respective newly-received hash for a respective chunk of the new update file is different from a respective prior hash of a prior software version for the same respective chunk, the respective prior hash relating to a previous update of the software or an original version of the software;
responsive to the respective newly-received hash for the respective chunk of the new update file being different from the respective prior hash for the same respective chunk, attempt to validate the respective chunk of the new update file using the respective hashing algorithm associated with the respective rank for the respective chunk of the new update file; and
responsive to the respective newly-received hash for the respective chunk of the new update file being the same as the respective prior hash for the same respective chunk, decline to attempt to validate the respective chunk of the new update file.

20. The CRSM of claim 19, wherein the different strengths of the different hashing algorithms are established at least in part by different numbers of iterations used for the different hashing algorithms, and wherein the determination is performed by comparing hashes in a hash tree for the new update file with hashes in a hash tree for the prior software version to identify a hash for a particular leaf indicated in both trees as having changed relative to the prior software version.
